(19) United States
(12) Patent Application Publication
(10) Pub. No.: US 2026/0311054 A1
(43) Pub. Date: Oct. 8, 2026

(54) Synthetic Data Generation Method and Apparatus

(71) Applicant: Telefonaktiebolaget LM Ericsson (publ), Stockholm (SE)

(72) Inventors: Haodong Zhao, Uppsala (SE); Rong Du, Bromma (SE); Ahsan Mahmood, Bro (SE)

(21) Appl. No.: 19/484,866

(22) PCT Filed: May 16, 2024
(86) PCT No.: PCT/EP2024/063583

§ 371 Date: Nov. 16, 2025

Related U.S. Application Data
(60) Provisional application No. 63/467,496, filed on May 18, 2023.

(51) Int. Cl. G06N 20/00; G06V 10/774; G06V 20/56

(52) U.S. Cl. CPC G06N 20/00; G06V 10/774; G06V 20/56

(57) ABSTRACT

A method of data generation, comprising selecting a plurality of variables to be constrained based on an optimisation problem. The method further comprises obtaining a plurality of reference points, wherein each of the plurality of reference points is respectively associated with one of the plurality of variables, and constraining the variables based on the plurality of reference points. The method additionally comprises generating synthetic data based on the plurality of variables and the plurality of reference points.

### TECHNICAL FIELD

The present disclosure relates to a computer implemented method for generating synthetic data. The method may be performed by a computing apparatus, and the present disclosure also relates to a computing apparatus and to a computer program product configured, when run on a computer, to carry out a method for generating synthetic data.

### BACKGROUND

Machine learning has been widely used in a wide variety of industries. In order to apply machine learning to an industry, a good set of data for training the machine learning algorithm should be obtained. In order for the training of the machine learning algorithm to provide good performance, the training data used should be as close to the reality as possible. To build a well-performing machine learning (ML) model, it may be beneficial to train the model on and test it against data that originates from the same target distribution. However, it may be very costly to collect sufficient real data for training. This cost may also be increasing due to the increasing sizes of AI models to be trained over time. This cost may be reduced by generating synthetic data, based on knowledge and simulation results of the real-world. One of the most popular approaches to generate synthetic data is Domain Randomization (DR). DR is intended to create a variety of simulated environments with randomized properties and train a model that works across all of them, such that the model may likely be adapted to the real world. This is because a real system is expected to match one of the simulated environments on which the model was trained.

FIG. 1 depicts an example of a DR synthetic data generation system, adapted from a figure available at https://lilianweng.github.io/posts/2019-05-05-domain-randomization/as of 18 May 2023. As shown in FIG. 1, a simulation may be calibrated using a plurality of domain-randomized simulations forming a domain-randomized simulation distribution. The constraints and properties representing reality coincide with one of the domain-randomized simulations, and accordingly the simulation has been calibrated such that the calibrated simulation may be applied to reality. That is, a DR system may generate a large set of training data, wherein a subset of the training data matches reality.

In addition to using the synthetic data from DR for ML training purposes, DR may also be used to generate multiple close-to-reality scenarios and run simulations in those scenarios, in order to find a best solution of a configuration and/or validate a particular concept.

As shown in FIG. 1, the feasible space of the parameters of a DR system may be high-dimensional. That is, there are multiple parameters to be randomised. In standard DR systems, the randomisation parameters may be uniformly sampled within associated bounded intervals. The randomized parameters may therefore be unrealistic, and the generated data accordingly may therefore include cases and data that are unrealistic. This unrealistic data may then need to be discarded from the training data set, and the process to generate synthetic data may accordingly be inefficient. Thus, existing approaches may be inefficient in generating close-to-real synthetic data due to the space to randomize the parameters (ξ) being high-dimensional, for example because existing approaches may not optimize the domain set for domain randomization (rather, existing approaches may simply run domain randomization on the entire domain set).

Other DR approaches may be based on Reinforcement Learning (RL) approaches, where DR results may be iteratively fed into an environment or simulator. In such a process, the environment or simulator may then generate a new batch of DR results based on the performance of the environment/simulator. However, using this process to get realistic DR results may be slow, for example if the simulator requires a long time to run a simulation.

### SUMMARY

It is an object of the present disclosure to provide a method, a computing apparatus, and a computer program product which at least partially address one or more of the challenges discussed above.

An embodiment of the present disclosure provides method of data generation. The method comprises selecting a plurality of variables to be constrained based on an optimisation problem. The method further comprises obtaining a plurality of reference points, wherein each of the plurality of reference points is respectively associated with one of the plurality of variables. The method additionally comprises constraining the variables based on the plurality of reference points, and generating synthetic data based on the plurality of variables and the plurality of reference points.

A further embodiment of the present disclosure provides a computing apparatus configured to generate data. The computing apparatus comprises processing circuitry and a memory containing instructions executable by the processing circuitry. The computing apparatus is operable to select a plurality of variables to be constrained based on an optimisation problem, obtain a plurality of reference points, wherein each of the plurality of reference points is respectively associated with one of the plurality of variables, constrain the variables based on the plurality of reference points, and generate synthetic data based on the plurality of variables and the plurality of reference points.

### BRIEF DESCRIPTION OF THE DRAWINGS

For a better understanding of the present disclosure, and to show more clearly how it may be carried into effect, reference will now be made, by way of example, to the following drawings in which:

FIG. 1 is a diagram of an example of a DR synthetic data generation system;

FIG. 2 is a flowchart showing a method in accordance with embodiments;

FIG. 3A and FIG. 3B (collectively referred to as FIG. 3) are schematic diagrams of a computing apparatus in accordance with embodiments;

FIG. 4 is a flowchart showing an iterative method in accordance with embodiments;

FIG. 5A and FIG. 5B (collectively referred to as FIG. 5) are schematic diagrams showing the generation of synthetic data in accordance with embodiments; and

FIG. 6 is a flowchart showing a method of using synthetic data in accordance with embodiments.

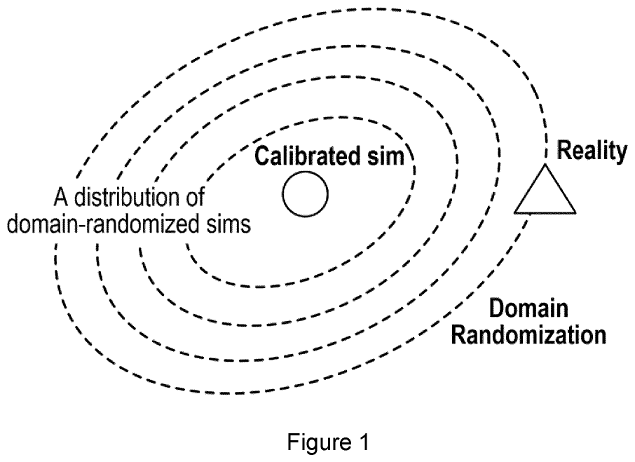

### DETAILED DESCRIPTION

Embodiments of the present disclosure may provide DR processes that take samples in the space of the parameters to be randomised. Embodiments of the present disclosure may also consider the concept of optimisation. Thus, constraints may be imposed that reflect reality when generating synthetic data using DR, which may reduce the space over which parameters are randomised. As the searching space may be reduced, the DR process may be more efficient and may produce less synthetic data that violates reality.

Regarding the constraints, embodiments of the present disclosure may not require the constraints to be linear. Accordingly, the constraints may be convex or may be non-convex. For non-convex constraints, relaxation may be used to convert the constraints into convex constraints.

For the purpose of explanation, details are set forth in the following description in order to provide a thorough understanding of the embodiments disclosed. It will be apparent, however, to those skilled in the art that the embodiments may be implemented without these specific details or with an equivalent arrangement.

The following sets forth specific details, such as particular embodiments for purposes of explanation and not limitation. It will be appreciated by one skilled in the art that other embodiments may be employed apart from these specific details. In some instances, detailed descriptions of well-known methods, nodes, interfaces, circuits, and devices are omitted so as to not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers that are specially adapted to carry out the processing disclosed herein, based on the execution of such programs. Nodes that communicate using the air interface also have suitable radio communications circuitry. Moreover, the technology may additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors, one or more processing modules or one or more controllers, and the terms computer, processor, processing module and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

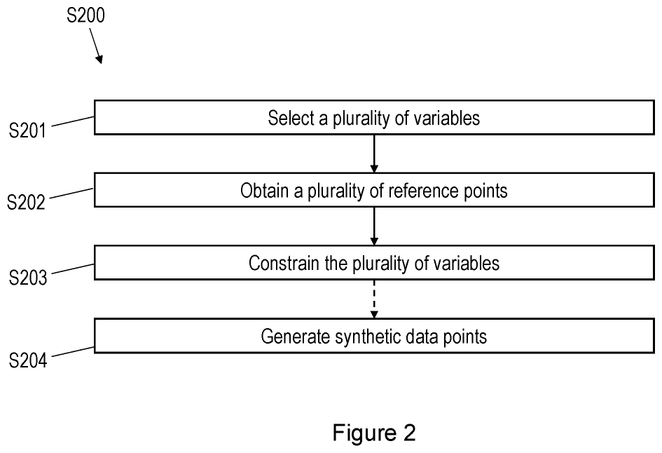

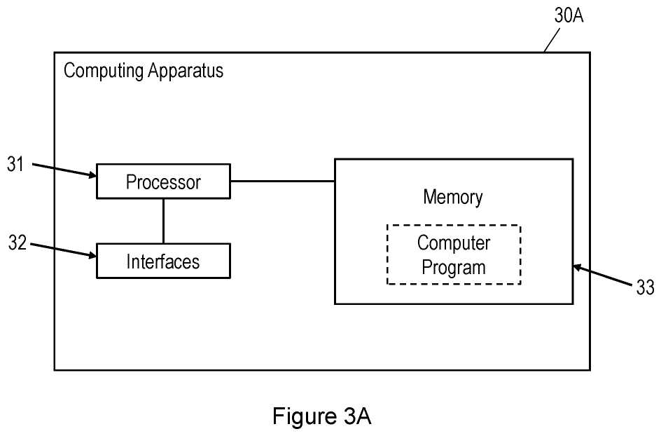

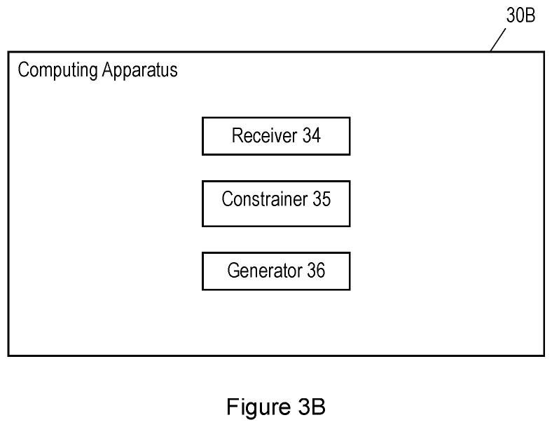

FIG. 2 is a flowchart showing a method in accordance with embodiments. Examples of suitable apparatus for performing the method shown in FIG. 2 are the computing apparatuses 30A and 30B shown schematically in FIG. 3A and FIG. 3B respectively; the computing apparatuses 30A and 30B may collectively be referred to using reference sign 30. The method may also be performed by any other suitable component or components, such as a further component of the computing infrastructure. The computing apparatuses 30 may be, for example all or part of core network nodes, base stations, or data centre controllers, and/or may be hosted in cloud computing systems. The computing apparatus 30A as shown in FIG. 3A may execute steps of the method in accordance with a computer program stored in a memory 33, executed by a processor 31 in conjunction with one or more interfaces 32. The computing apparatus 30B as shown in FIG. 3B may execute steps of the method using receiver 34, constrainer 35, and generator 36. The computing apparatuses 30A and 30B may also be configured to execute the steps of other embodiments, as discussed in detail below.

As shown in Step S201 of FIG. 2, embodiments of the present disclosure may include selecting a plurality of variables to be constrained based on an optimisation. In specific embodiments, the method may additionally comprise formulating an optimisation problem. The optimisation problem may be in the format of Equation 1:

$$\begin{matrix}{min}_{ξ} {‖ ξ - w ‖}^{2} \\ s . t . ξ ∈ Ξ\end{matrix} \qquad Equation 1 : An example optimisation problem$$

Formulation of the optimisation problem may include knowledge from human experts and/or real world data. In specific examples, formulation of the optimisation problem may be based on the application to which the synthetic data may be applied, such that the variables to be randomised may be chosen more accurately.

As shown in Step S202 of FIG. 2, the method may comprise obtaining a plurality of reference points (wₛ, wₘ, wₐ), wherein each of the plurality of reference points may be respectively associated with one of the plurality of variables. The reference points may be uniform randomly over the whole space without the need to consider the constraints that come from reality. Alternatively, the plurality of reference points (wₛ, wₘ, wₐ) may be arbitrarily distributed. Obtaining the plurality of reference points (wₛ, wₘ, wₐ) may comprise randomly generating the plurality of reference points (wₛ, wₘ, wₐ). Alternatively, the plurality of reference points may be obtained from human expert knowledge. Further alternatively, the plurality of reference points may be obtained through a two-level iterative process.

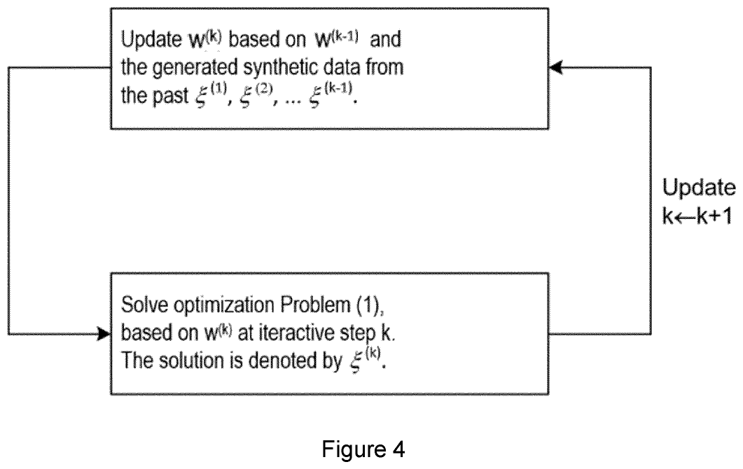

FIG. 4 depicts a flowchart showing an iterative method in accordance with embodiments. As shown in FIG. 4, the DR process may be a two-level iterative process. In the low level, a solution may be found for the parameters to be randomised (ξ, with N variables) by solving the optimisation problem in the form of Equation 1 (or Problem 1), where Ξ is the space where a variable to be constrained ξ is feasible in reality, and a reference point w is an output from the upper level. In specific examples, the space Ξ may be determined using human expert knowledge. The inclusion of multiple constraints that reflect reality to be considered the space Ξ may provide a smaller space such that a larger subset of the data generated by the DR reflects reality. The number of constraints included may be determined by the desired speed with which a given amount of data reflecting reality may be generated by embodiments. For example, a higher number of constraints may reduce the speed at which synthetic data is generated (that is, more time may be needed).

After the upper level step of the two-level iterative process which may generate a plurality or batch of reference points w^{(k)}, an additional step may be performed to determine whether one or more of the reference points satisfy all of the constraints in the optimisation problem in the lower level. For any of the one or more points

$${w}_{i}^{( k )}$$

that satisfy all of the constraints, embodiments may include a further step of setting

$${ξ}_{i}^{( k )} = {w}_{i}^{( k )}$$

such that it is no longer necessary to determine a full solution to the optimisation problem. This may result in improved speed of execution of the method. Accordingly, specific embodiments may further comprise the steps of determining if setting the plurality of variables (ξₛ, ξₘ, ξₐ) equal to the plurality of reference points (wₛ, wₘ, wₐ) results in a solution to the optimisation problem, and if it is determined that setting the plurality of variables (ξₛ, ξₘ, ξₐ) equal to the plurality of reference points (wₛ, wₘ, wₐ) results in a solution to the optimisation problem, setting ξᵢ=wᵢ for all values of i.

As shown in Step S203 of FIG. 2, the method may comprise constraining the variables ξ based on the plurality of reference points (wₛ, wₘ, wₐ). Constraining the variables ξ may comprise solving the optimisation problem, for example in the format of Equation 1. In some examples, the solution to Equation 1 may be efficient and/or simple, for example if the optimisation problem is a convex optimisation problem. That is, Equation 1 may be convex if the constraints applied (the space Ξ) is convex. Many constraints that represent reality may be convex, however some constraints may be non-convex. In the case of non-convex constraints, the constraints may be relaxed so as to be modelled as convex constraints. Alternatively, the non-convex constraints may not be relaxed and Equation 1 may be solved using the full non-convex constraints.

That is, if the optimisation problem comprises non-convex constraints in Ξ′, specific embodiments may comprise a further step of relaxing the non-convex constraints to convex constraints such that

$${Ξ}_{r}^{′} = {Ξ}^{′} ⋃ {Ξ}_{s} ,$$

where Ξₛ is the complementary space that relaxes the original non-convex constraints Ξ′ into convex constraints Ξᵣ′. In such a case, Equation 1 may become a convex optimisation, and may have an optimal solution that may be found in polynomial time. For such solutions, some constrained variables ξₛ may lie in the complementary space ξₛ and thus may need to be excluded in the output generated synthetic data.

The upper level of the two-level iterative process may be an updating process of the reference point (w) based on the results in the lower level (ξ), that is, based on the already generated synthetic data. Accordingly, the two-level iterative process may ensure that the synthetic data generated after the DR process has ended is as close-to-reality as possible. Alternatively or additionally, the two-level iterative process may ensure that the synthetic data generated after the DR process is as uniform as possible, which may be useful for example if the data is to be used for ML validation. Reference points w do not need to satisfy the space to be constrained Ξ.

As shown in Step S204 of FIG. 2, the method may further comprise generating synthetic data based on the plurality of variables and the plurality of reference points. That is, the method may comprise iteratively generating constrained variables ξ and updating reference points w until enough synthetic data has been generated. After a certain number of iterations, for example when a suitable amount of data has been generated or a suitable number of parameters/variables ξ have been randomised, the algorithm may be terminated and the parameters/variables ξ that have been randomised may be output as the generated synthetic data. In this way, specific embodiments may comprise performing steps S201, S202, S203, and S204 of FIG. 2 for the plurality of reference points (w^{(k)}) at iterative step k to generate synthetic data at iterative step k, updating the plurality of reference points (w^{(k)}) at iterative step k to obtain the plurality of reference points (w^{(k+1)}) at iterative step k+1 based on the plurality of reference points (w^{(k)}) at iterative step k and the plurality of variables (ξ^{(k)}) at iterative step k, and repeating the steps of Claim 1 for the plurality of reference points (w^{(k+1)}) at iterative step k+1 to generate further synthetic data at iterative step k+1.

In specific examples, the method may further comprise repeating the steps of the method for a number of iterations n. The number of iterations may be

$$n \geq \frac{{n}_{total}}{{n}_{w}}$$

where nₜₒₜₐₗ is the number of synthetic data points to be generated and n_{w} is the number of reference points forming the plurality of reference points. In more specific examples, it may be that

$$n = \frac{{n}_{total}}{{n}_{w}} ,$$

for example when the constraints to be considered are convex. Alternatively, it may be that

$$n = \frac{2 {n}_{total}}{{n}_{w}} ,$$

for example when the constraints are non-convex and were then relaxed to be convex. In such a case, some of the generated synthetic data may violate the constraints due to inaccuracies introduced due to relaxing the constraints and this data will need to be discarded and thus additional data generation may be needed. In further specific examples, it may be that

$${n}_{w} = \sqrt{{n}_{total}} .$$

In specific examples, the total number of synthetic data to be generated nₜₒₜₐₗ may be dependent on the ML for which the synthetic data will be used. For example, nₜₒₜₐₗ may be dependent on the size of the ML model. In specific examples, nₜₒₜₐₗ may be equal to 10 times the number of degrees of freedom of the ML model.

An advantage of the present embodiments may be that generation of non-realistic synthetic data may be avoided, and thus the overall efficiency of the synthetic data generation method may be improved. Present embodiments may also allow for improved control over the randomness of the data generation due to the update of the randomness reference points in the upper level of the two-level iterative process.

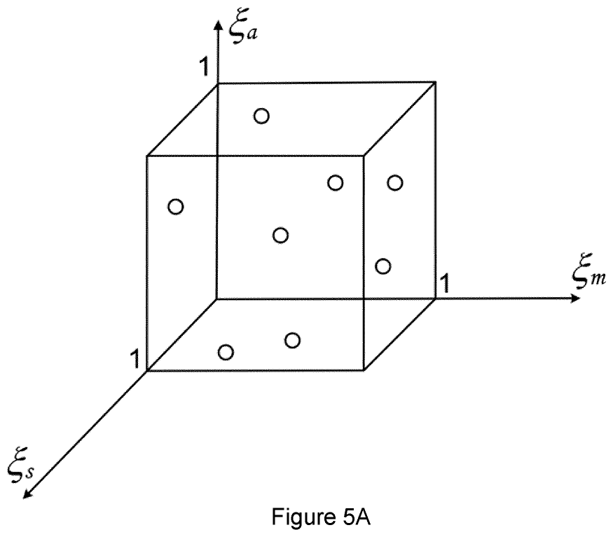

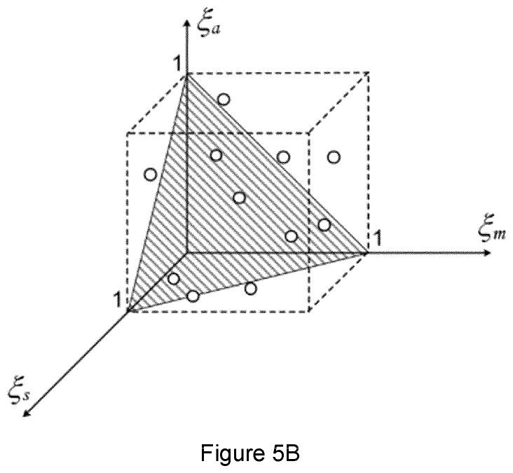

FIG. 5 depicts a specific example generation of synthetic data in accordance with embodiments. In this specific example, synthetic data may be generated relating to synthetic factories with different layouts. However, it will be appreciated that aspects of the specific example may be applied to other situations.

In a factory, there may be several areas in the shopfloor, such as warehouse/storage areas, machining areas, assembly areas, and workshop areas. To generate factories with different layouts, a DR system may be used wherein the parameters to be randomized are the sizes of any areas present, and based on the size of the areas a factory may be randomly separated into different zones for different areas. For the specific example considered in FIG. 5, it may be assumed that there are three areas in the factory: a storage area, a machining area, and an assembly area.

As the variables to be constrained, ξₛ, ξₘ, ξₐ may be used as the ratio of the storage, machining, and assembly areas to the size of the factory, respectively. Then, at least four constraints may be used to define the space

$$0 \leq {ξ}_{s} \leq 1 ,$$

$$0 \leq {ξ}_{m} \leq 1 ,$$

$$0 \leq {ξ}_{a} \leq 1$$

$${ξ}_{s} + {ξ}_{m} + {ξ}_{a} = 1$$

Additional constraints may also be used, denoted by Ξ′.

In a typical DR approach, ξₛ, ξₘ, ξₐ may be uniform randomly chosen from [0, 1], such that the space Ξ of the generated ξₛ, ξₘ, ξₐ is a unit cube in the 3-d axis within which all generated ξₛ, ξₘ, ξₐ are present. This is shown by in FIG. 5A.

In the specific example of FIG. 5 there are three random variables per synthetically generated data point, however in other examples more variables per synthetically generated data point may be present. That is, it may be the case that ξᵢ, (i=1 . . . nₜₒₜₐₗ), where nₜₒₜₐₗ is the total number of data points to be generated, and for each data point ξᵢ=(ξ_{i,1}, ξ_{i,2}, . . . ξ_{i,m}) is a set of variables of size m. Corresponding nomenclature may be used for other variables such as the reference points wᵢ.

From FIG. 5A, it may be observed that many results will violate the requirement that ξₛ+ξₘ+ξₐ=1. Accordingly, many elements of the generated synthetic data represented as points in FIG. 5A may not make sense in reality and may produce undesirable results if not removed from the synthetic data before use. Thus, an optimisation problem may be formulated in the form of Equation 2:

$${{min}_{{ξ}_{s} , {ξ}_{m} , {ξ}_{a}} ( {ξ}_{s} - {w}_{s} )}^{2} + {( {ξ}_{m} - {w}_{m} )}^{2} + {( {ξ}_{a} - {w}_{a} )}^{2}$$

$$s . t . 0 \leq {ξ}_{s} \leq 1 ,$$

$$0 \leq {ξ}_{m} \leq 1 ,$$

$$0 \leq {ξ}_{a} \leq 1 ,$$

$${ξ}_{s} + {ξ}_{m} + {ξ}_{a} = 1 ,$$

$${ξ}_{s} , {ξ}_{m} , {ξ}_{a} ∈ {Ξ}^{′}$$

Equation 2: An optimisation problem for the specific example as depicted in FIG. 5

By analyzing the constraints of Equation 2, it may be seen that the space Ξ associated with ξₛ, ξₘ, ξₐ is a triangular plane as shown in FIG. 5B. Thus, the resulting ξₛ, ξₘ, ξₐ found by solving the above optimisation problem may only fall within the triangular plane, that is, may only satisfy the constraints 0≤ξₛ≤1, 0≤ξₘ≤1, 0≤ξₐ≤1, ξₛ+ξₘ+ξₐ=1. Accordingly, the locations of each of the solutions ξₛ, ξₘ, ξₐ in the triangular plane depends on the reference point (wₛ, wₘ, wₐ) associated with the solution, which may come from an upper level update in a two-level iterative process as detailed above. In order to generate random ξₛ, ξₘ, ξₐ the reference points may also have some associated randomness. The upper level update may adjust the random generator of w=(wₛ, wₘ, wₐ), such that the resulting ξₛ, ξₘ, ξₐ may distribute as even as possible in the green plane. For example, in the initialization a batch of initial reference points w⁽⁰⁾ may be generated (for example, N reference points

$${w}_{1}^{( 0 )} , {w}_{2}^{( 0 )} , … {w}_{N}^{( 0 )} )$$

arbitrarily in R³. For each

$${w}_{i}^{( 0 )} ,$$

the reference point may be put into the optimisation problem of Equation 2 to get a solution

$${ξ}_{1}^{( 0 )} , {ξ}_{2}^{( 0 )} , … , {ξ}_{N}^{( 0 )} .$$

Then, based on the distribution of the points

$${ξ}_{1}^{( 0 )} , {ξ}_{2}^{( 0 )} , … , {ξ}_{N}^{( 0 )} ,$$

it may be seen that, for example, the generated constrained variables are concentrated in the lower part of the triangle, that is, the number of points whose ξₐ>0.7 are too little. In such a case, it may be desirable to update in iteration step k=1 that w⁽¹⁾ has a higher probably to have large wₐ such that the next iteration generates solutions in an area of the triangular plane with lower concentrations of generated synthetic data.

When updating w, it may be desirable to spread the points represented by w in the feasible space of ξ iteratively. Accordingly, each reference point (w^{(k)} or

$${w}_{i}^{( t )} , )$$

may have an associated reference point offset (v^{(k)}). The reference point offset may for example be a random vector of unit size with a random direction.

Thus, specific embodiments may further comprise updating the plurality of reference points (w^{(k)}) at iterative step k to obtain the plurality of reference points (w^{(k+1)}) at iterative step k+1 using the equation:

$${w}^{( k + 1 )} = {w}^{( k )} + {v}^{( k )}$$

Specific embodiments may additionally comprise updating the associated reference point offset (v^{(k)}) for each of the plurality of reference points (w^{(k)}) at iterative step k to obtain an associated reference point offset (v^{(k+1)}) for each of the plurality of reference points (w^{(k+1)}) at iterative step k+1.

In specific embodiments, updating the associated reference point offset (v^{(k)}) for each of the plurality of reference points (w^{(k)}) may comprise using an update function v^{(k+1)}=f(v^{(k)}, ξ^{(k)}, w^{(k)}). The update function may comprise one or more of the following functions:
1. v^{(k+1)}=α(ξ^{(k)}−w^{(k)}) where α≤1 and is a positive value (in such an example the update may be representing a force to drag w towards the result point ξ);
2. v^{(k+1)}=αv^{(k)} where α≤1 and is a positive value (in such an example the update may be representing a momentum of the moving point w^{k});
3.

$${v}^{( k + 1 )} = {\sum }_{j \neq i} \frac{{ξ}_{i}^{( k )} - {ξ}_{j}^{( k )}}{{{d}^{k} ( i , j )}^{2} )}$$

wherein i,j are positive integer values and d^{k}(i,j) is a distance between

$${ξ}_{i}^{( k )} and {ξ}_{j}^{( k )}$$

(in such an example d(i,j) may represent the distance between

$${ξ}_{i}^{( t )} and {ξ}_{j}^{( t )} .$$

This update may therefore represent forces that keep the resulting points away from each other);
4. f(v^{(k)}, ξ^{(k)}, w^{(k)}) is a random unit vector (in such an example the update may be representing some random perturbation).

In specific examples, the method may comprise normalising each associated reference point offset (v^{(k+1)}) for each of the plurality of reference points (w^{(k+1)}) at iterative step k+1. This may be done to ensure that the reference point offset does not diminish to 0 (which may result in no update of w^{(k)}) or become a value too large (which may result in unrealistic synthetic data being generated).

Accordingly, in specific embodiments upper level updates of the reference points may be used to achieve a degree of randomness in the DR process. The lower level may solve the optimisation problem in order to find the projection of the reference points onto the space where the constraints are satisfied.

The above example of FIG. 5 is related to generating a scenario for simulation, however it should be appreciated that aspects thereof may be applied to other use cases. For example, in a radio product that may support multiple bands, a power pooling solution may be found using present embodiments that may split power into multiple bands. Furthermore, present embodiments may be used to validate the efficacy of a policy consisting of rules (which may be converted into constraints) for power splitting. Present embodiments may then be used to randomly generate possible power splits, which may be used as input to a simulator to simulate network performance. Accordingly, in such embodiments, the optimisation problem considered may be or may originate from a communications problem, the synthetic data may be data for a network simulator, and the plurality of variables may be one or more of the following: variables relating to policy rules for power splitting; a number of available bands; and/or a size of available bands. Such embodiments may also comprise using the synthetic data to train a network management algorithm, and subsequently using the network management algorithm to assist with the control of traffic in a communications network.

Alternatively, present embodiments may be used to evaluate a scheduling algorithm or network slicing algorithm. For example, the algorithm may include mixed traffic, where the mixed traffic may consist of one or more of: Enhanced Mobile Broadband (eMBB) traffic, Extended Reality (XR) traffic (Augmented Reality (AR) traffic, Virtual Reality (VR) traffic, Mixed Reality (MR) traffic), Ultra-Reliable Low Latency Communications (URLLC) traffic, and/or ping traffic. Present embodiments may then be used to test different numbers of users that generate different traffic, according to the statistical knowledge available.

For example, factory scenarios may be generated with varying numbers of user devices with different traffic types (e.g. eMMB, AR, VR, XR, URLLC, and/or ping traffic) and radio deployment. Possible variables ξ^{k} to be considered may include one or more of: the area of the factory, the size of the storage/machining/assembly areas and/or any other available areas in the factory, the ratio of different traffic devices in each area, and/or any objects in each area (e.g. machines, assembly lines, Automated Guided Vehicles (AGVs), forklifts, and/or pallet racks) and their corresponding locations. Using the approach described above, multiple results for each constrained variable ξ^{k} are obtained. The constraints obtained may be in the form of any one of the following: variables lying within a certain range, weighted sum of the variables being less than/larger than/equal to a value, and/or the Euclidian distance between the variables to a given point is less than/equal to a value (for example, the size of each area or number of devices of each traffic type may be in a certain range, the total size or total number of devices may be less than/larger than/equal to a certain number, and/or the difference between the generated result and a real world expectation should be less than/equal to a certain value).

Accordingly, in such embodiments, the optimisation problem may be or may originate from a communications problem, the synthetic data may be data for training a scheduling algorithm or a network slicing algorithm for a local area, and the plurality of variables may be one or more of the following: an overall area of the local area; a number of constituent areas of the local area; a size of a storage area in the local area; a size of a machining area in the local area; a size of an assembly area in the local area; a number of traffic types used in the local area; a ratio of each traffic type used in the local area; a ratio of each traffic type used in each area of the local area; a number of radios deployed in the local area and/or their corresponding locations; and/or a number of objects in each area of the local area. The local area may be a factory. Alternatively, the local area may be any one of a campus area, a mall, an office, a sea-port, or a railway terminal.

Such embodiments may also comprise using the synthetic data to train the scheduling algorithm or network slicing algorithm, and subsequently using the scheduling algorithm to assist with the configuration of the factory. Alternatively, such embodiments may also comprise using the synthetic data to test the scheduling algorithm or network slicing algorithm.

The goal of the present embodiments may be to evaluate a specific feature of scheduling algorithm, for example how to serve the different traffic types in a factory scenario or more specifically how to prioritize the different traffic types based on the network cell load such that a performance requirement r is met. The scheduling algorithm may be implemented into the network simulator, and the simulator ran with the variables generated using present embodiments (ξ). The results generated by the simulator may indicate the performance of the network, and it may be determined whether such a configuration meets the performance requirements. The network simulator may be configured to run Monte-Carlo simulations.

In a further specific example, the purpose of the present embodiments may be to achieve a policy to instruct on how to deploy radio products in an input indoor floor factory environment. This may be, for example, to achieve a performance requirement such as capacity, latency, and/or reliability of communication. Variables to be considered (ξ) may include one or more of: information regarding the factory including the size of different areas, the number of objects in each area and their corresponding locations, number of devices for each type of traffic, amounts for each type of traffic in total and/or per device, requirements for capacity/latency/reliability, and/or the candidate ratio product to be deployed. The decision or output of the method may be a specific deployment, such as the inter-distance of the deployed radios (for example, density and/or number of radios to be deployed) and/or suggested locations for deployed radios.

Alternatively, present embodiments may be used to achieve a policy to estimate the capacity/latency performance with given inputs, with the associated output being an estimate as to the capacity/latency performance with given inputs. In such embodiments, variables to be constrained may be the same as for previous examples such as information regarding the factory, traffic in the factory and deployment information regarding radio products within the factory, as discussed above.

For example, in order to validate that a private network configuration in factories with 50 URLLC user equipments (UEs) per cell can achieve a latency performance of x millisecond with 99.999% reliability, DR may be used to generate a huge number of scenarios, where the layout of the factories, the UE locations, the outdoor network, and/or the UE traffic, for example, are randomly generated in different scenarios. Simulations may then be run on the generated scenarios and the simulation results may be analyzed to see whether the statement is correct or not.

In any of the specific embodiments above, DR may be used to generate multiple factory scenarios, with varying numbers of user devices with different traffic types and radio deployments (provided by the constrained variables ξ). For each set of synthetic factory parameters, a 3D modelling tool may be used (e.g. Omniverse™ by Nvidia) to build a digital twin model of the synthetic factory. Furthermore, traffic information generated by present embodiments may be provided into the network simulator. The network simulator may achieve a result for performance requirement r in terms of the network performance (for example, coverage, throughput, and/or latency) for each input combination of factory, deployment, and traffic variables ξ.

The generated variables and performance requirements r may then be used to train a neural network, with the variables as input and the performance requirements r as outputs. The neural network ML model can then be used to generate factory layout and traffic information using candidate deployments as inputs, in order to obtain estimated network performances under different candidate deployments. The candidate deployment with the optimum performance can then be provided to a consumer as a suggested deployment.

Further specific examples of present embodiments include applying the DR approach to areas of materials/chemistry/biology. For example, present embodiments may be used to determine a material that is a compound of multiple materials. A simulation may be used to evaluate the performance of the new material and find the best combination of the multiple materials based on the simulations.

A further example of the present embodiments (that is, using DR for machine learning) may be using present embodiments for autonomous-driving; DR may be used to generate the images/lidar/other sensors data to train the autonomous-driving algorithms, where the parameters (ξ) to be randomized in DR may be one or more of: the position, shape, and/or colour of objects (e.g. pedestrian, lane, and other vehicles), the lighting condition, the road condition, the location, orientation and/or field of view of the camera. Accordingly, in such embodiments the optimisation problem may be or may originate from an autonomous driving problem, the synthetic data may be data for training an autonomous-driving algorithm, and the plurality of variables may be one of more of the following: road related variables; variables relating to objects on a road; environment related variables; sensor related variables; and/or variables relating to the condition of a vehicle to be considered in the autonomous driving problem. Further, methods of such embodiments may further comprise using the synthetic data to train the autonomous-driving algorithm, and subsequently using the autonomous-driving algorithm to assist with the control of a vehicle.

More specifically, for specific embodiments directed to an autonomous driving use case, DR may be applied to generate synthetic scenes (for example, photo realistic scenes) in a digital twin of the real-world. After this, cameras (which may be randomly deployed in the scene) may be used to capture images for training or testing. The training/testing purpose may be one or more of the following: detection of object/vehicle/pedestrians, driving or parking policy training such as speed control for improved time efficiency or energy efficiency, policy creation for braking when needed or when an anomaly is detected, and/or policy creation for turning to change lane or avoid collisions.

Accordingly, the training/testing data for such embodiments may be the images/video captured by the ‘camera’ in the digital twin of the (synthetic) driving scenarios, wherein the scenes may be generated by DR. That is, a scene generator (based on DR) may be used to generate training data (images/videos/or sensory data). In the scene generator, the variables that may be randomized include one or more of the following, which may be selected based on the specific problem under study:
1. Road related variables: for example, a number of lanes, width of the lanes (which may follow some range constraints), colour of the lanes (for example, gray or soil colour for standard lanes, red for bus lanes, and/or any other specific colour which a lane may be painted in order to indicate specific activities), the texture of the road (for example, to mimic leaves/dirt marks/road marks on the road), and/or the height of the curb (which may follow some range constraints);
2. Variables relating to objects on a road: for example, the location of traffic lights on the road, one or more of the number/position/orientation/size/type/trajectory of vehicles and/or any anomaly in objects that cross the road (for example, pedestrians, bikes, road-blocks, animals, obstacles, wheelchairs, strollers, and/or robots);
3. Environment related variables: for example, information regarding Objects (for example, the sizes and locations of the objects) that are on the road side (for example: buildings, sidewalks, bushes, trees, and/or pedestrians), weather and lighting conditions (for example: information regarding ambient lighting conditions or light from other sources such as direction and strength);
4. Sensor related variables: for example, the number/position/tilting/field of view of any cameras/sensors such as LIDAR sensors, any distances between the devices if multiple devices are present (and in such a case, the positions and the distances may be formulated as coupled constraints), and/or any shadowing present on the sensor(s) (for example, to model a part of a sensor that may be blocked by some other object);
5. Variables relating to the condition of a vehicle to be considered in the autonomous driving problem: for example speed/acceleration/mass/gear/pressure in the tyres of the vehicle, and/or any other data that may come from an onboard sensor on a vehicle to be considered.

If a reference scene is present (for example, where the ML algorithm performance is not good enough and it is desirable to reproduce more scenes that are similar to the reference scene) then the variables mentioned above may be taken from the reference scene to be used as inputs (ξ) and a constraint |ξ−ξᵣ|²≤dᵣ may be added when generating new scenes, where dᵣ denotes a threshold for the difference between the generated variables and the reference variables.

As mentioned above, once the scenes are generated, training or testing data may be generated from the camera/LIDAR/sensory data. The ML algorithm to be trained using the training/testing data may be any one of: a neural network for image object detection (for example to evaluate whether objects such as lanes, pedestrians, traffic signs, obstacles can be detected in different lighting or shadowing environments), or a policy trained by reinforcement learning (RL) (for example to make the self-driving of the vehicle smooth, safe, and/or fast). In the RL case, for example, the ‘environment’ variables may be the synthetic data generated by DR, the action space of the agent may include for example the acceleration, deceleration, steering, braking, and/or turning on/off the light of vehicles. The specific embodiment may also be applied to the training of autonomous guided vehicles in factories or outdoor for good delivery, and for remote driving vehicles.

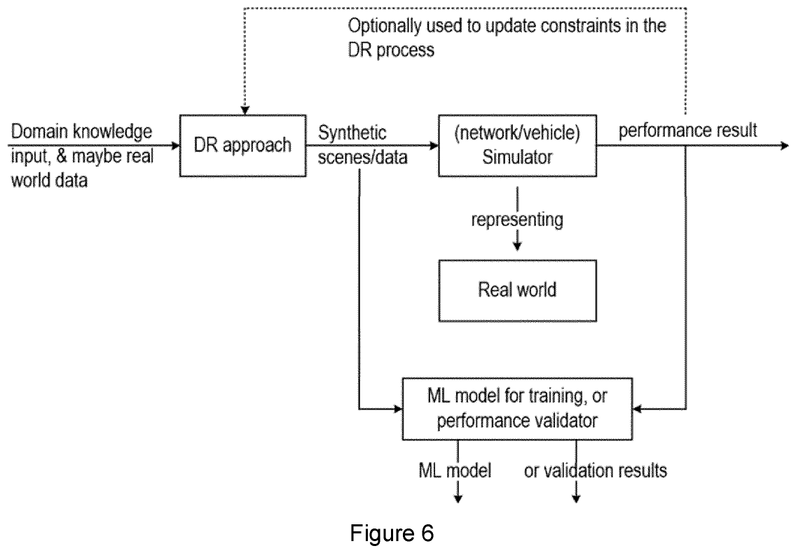

FIG. 6 presents a flowchart showing a method of using synthetic data in accordance with embodiments. As shown in FIG. 6, domain knowledge and/or real world data may be input into the method of specific embodiments, in order to determine the variables to be constrained and the specific constraints applied through the determination of the optimisation problem. The DR approach aspect as shown in FIG. 6 forms the steps of the present embodiments of constraining the variables ξ and generating synthetic data. The synthetic scenes or data generated from this DR approach may then be fed into a simulator for a vehicle or network in order to generate performance results or a ML model for training or performance validation, as discussed above. Performance results from the simulator or ML model may additionally be used to update constraints in the DR process in specific embodiments.

It will be appreciated that examples of the present disclosure may be virtualised, such that the methods and processes described herein may be run in a cloud environment.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure. For the avoidance of doubt, the scope of the disclosure is defined by the claims.

1.-37. (canceled)

38. A method of data generation, comprising:
selecting a plurality of variables ξ=(ξ₁, ξ₂, . . . , ξᵢ) to be constrained based on an optimization problem, wherein i=1, . . . nₜₒₜₐₗ, where nₜₒₜₐₗ is the total number of data points to be generated;
obtaining a plurality of reference points w=(w₁, w₂, . . . , wᵢ), wherein each of the plurality of reference points is respectively associated with one of the plurality of variables;
constraining the variables based on the plurality of reference points w=(w₁, w₂, . . . , wᵢ); and
generating synthetic data based on the plurality of variables and the plurality of reference points.

39. The method of data generation, comprising:
performing the steps of claim 38 for the plurality of reference points (w^{(k)}) at iterative step k to generate synthetic data at iterative step k;
updating the plurality of reference points (w^{(k)}) at iterative step k to obtain the plurality of reference points (w^{(k+1)}) at iterative step k+1 based on the plurality of reference points (w^{(k)}) at iterative step k and the plurality of variables (ξ^{(k)}) at iterative step k; and
repeating the steps of claim 38 for the plurality of reference points (w^{(k+1)}) at iterative step k+1 to generate further synthetic data at iterative step k+1.

40. The method of claim 39, wherein the method further comprises repeating the steps of claim 39 for a number of iterations n.

41. The method of claim 40, wherein
$$n \geq \frac{{n}_{total}}{{n}_{w}}$$
and wherein nₜₒₜₐₗ is the number of synthetic data points to be generated and n_{w} is the number of reference points forming the plurality of reference points w in each iteration step.

42. The method of claim 41, wherein
$$n = \frac{{n}_{total}}{{n}_{w}}$$
or wherein
$$n = \frac{2 {n}_{total}}{{n}_{w}} .$$

43. The method of claim 41, wherein n_{w}=\sqrt{nₜₒₜₐₗ}.

44. The method of claim 39, wherein each reference point (w^{(k)}) has an associated reference point offset (v^{(k)}), and wherein the method further comprises:
updating the plurality of reference points (w^{(k)}) at iterative step k to obtain the plurality of reference points (w^{(k+1)}) at iterative step k+1 using the equation:
$${w}^{( k + 1 )} = {w}^{( k )} + {v}^{( k )}$$

45. A computing apparatus configured to generate data, the computing apparatus comprising processing circuitry and a memory containing instructions executable by the processing circuitry, whereby the computing apparatus is operable to:
select a plurality of variables ξ=(ξ₁, ξ₂, . . . , ξᵢ) to be constrained based on an optimization problem, wherein i=1, . . . nₜₒₜₐₗ, where nₜₒₜₐₗ is the total number of data points to be generated;
obtain a plurality of reference points w=(w₁, w₂, . . . , wᵢ), wherein each of the plurality of reference points is respectively associated with one of the plurality of variables;
constrain the variables based on the plurality of reference points w=(w₁, w₂, . . . , wᵢ); and
generate synthetic data based on the plurality of variables and the plurality of reference points.

46. The computing apparatus of claim 45, wherein the computing apparatus is further operable to:
perform the select, obtain, constrain, and generate operations of claim 45 for the plurality of reference points (w^{(k)}) at iterative step k to generate synthetic data at iterative step k;
update the plurality of reference points (w^{(k)}) at iterative step k to obtain the plurality of reference points (w^{(k+1)}) at iterative step k+1 based on the plurality of reference points (w^{(k)}) at iterative step k and the plurality of variables (ξ^{(k)}) at iterative step k; and
repeat the select, obtain, constrain, and generate operations of claim 45 for the plurality of reference points (w^{(k+1)}) at iterative step k+1 to generate further synthetic data at iterative step k+1.

47. The computing apparatus of claim 46, wherein the computing apparatus is further configured to perform the repeat operation of claim 46 until a number of iterations n is completed.

48. The computing apparatus of claim 47, wherein
$$n \geq \frac{{n}_{total}}{{n}_{w}}$$
and wherein nₜₒₜₐₗ is the number of synthetic data points to be generated and n_{w} is the number of reference points forming the plurality of reference points (w₁, w₂, . . . , wᵢ).

49. The computing apparatus of claim 48, wherein
$$n = \frac{{n}_{total}}{{n}_{w}}$$
or wherein
$$n = \frac{2 {n}_{total}}{{n}_{w}} .$$

50. The computing apparatus of claim 48, wherein n_{w}=\sqrt{nₜₒₜₐₗ}.

51. The computing apparatus of claim 46, wherein each reference point (w^{(k)}) has an associated reference point offset (v^{(k)}), and wherein the computing apparatus is further configured to:
update the plurality of reference points (w^{(k)}) at iterative step k to obtain the plurality of reference points (w^{(k+1)}) at iterative step k+1 using the equation:
$${w}^{( k + 1 )} = {w}^{( k )} + {v}^{( k )}$$
